(19) United States
(12) Patent Application Publication
(10) Pub. No.: US 2019/0373322 A1
(43) Pub. Date: Dec. 5, 2019

(54) Interactive Video Content Delivery

(71) Applicant: Sony Interactive Entertainment LLC, San Mateo, CA (US)

(72) Inventors: Fernan Rojas-Echenique, San Francisco, CA (US); Martin Sjoelin, Redwood City, CA (US); Utku Mert, Berkeley, CA (US); Shaheed Shaik, Fremont, CA (US); Mani Kishore Chitrala, Union City, CA (US)

(21) Appl. No.: 15/991,438

(22) Filed: May 29, 2018

(51) Int. Cl. H04N 21/466; H04N 21/472; G06F 17/30; H04N 21/2187; G06F 15/18

(52) U.S. Cl. CPC H04N 21/4665; H04N 21/4663; G06F 15/18; G06F 17/30817; H04N 21/2187; H04N 21/472

(57) ABSTRACT

The disclosure provides methods and systems for interactive video content delivery. An example method comprises receiving a video content such as live television or video streaming. The method can run one or more machine-learning classifiers on video frames of the video content to create classification metadata corresponding to the machine-learning classifiers and one or more probability scores associated with the classification metadata. Furthermore, the method can create one or more interaction triggers based on a set of predetermined rules and optionally user profiles. The method can determine that a condition for triggering at least one of the triggers is met and triggers at least one of the actions with regard to the video content based on the determination, the classification metadata, and the probability scores. For example, the action can deliver additional information, present recommendations, automatically edit the video content, or control delivery of video content.

### TECHNICAL FIELD

This disclosure generally relates to video content processing, and more particularly, to methods and systems for interactive video content delivery in which various actions can be triggered based on classification metadata created by machine-learning classifiers.

### DESCRIPTION OF RELATED ART

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Television programs, movies, videos available via video-on-demand, computer games, and other media content can be delivered via the Internet, over-the-air broadcast, cable, satellite, or cellular networks. An electronic media device, such as a television display, personal computer, or game console at a user's home, has the ability to receive, process, and display the media content. Modern-day users are confronted with numerous media content options that are readily and immediately available. Many users, however, find it difficult to interact with the media content (e.g., to select additional media content or to learn more about certain objects presented via the media content).

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is directed to interactive video content delivery. The technology provides for receiving a video content, such as live television, video streaming, or user generated video, analyzing each frame of the video content to determine associated classifications, and triggering actions based on the classifications. The actions can provide additional information, present recommendations, edit the video content, or control the video content delivery, and so forth. A plurality of machine-learning classifiers is provided to analyze each buffered frame to dynamically and automatically create classification metadata representing one or more assets in the video content. Some exemplary assets include individuals or landmarks appearing in the video content, various predetermined objects, food, purchasable items, video content genre(s), information on audience members watching the video content, environmental conditions, and the like. Users may react to the actions being triggered, which may improve their entertaining experience. For example, users may search information concerning actors appearing in the video content, or they may watch another video content with those actors. As such, the present technology allows for intelligent, interactive, and user-specific video content delivery.

According to one example embodiment of the present disclosure, a system for interactive video content delivery is provided. An example system can reside on a server, in a cloud-based computing environment; can be integrated with a user device; or can be operatively connected to the user device, directly or indirectly. The system may include a communication module configured to receive a video content, which includes one or more video frames. The system can also include a video analyzer module configured to run one or more machine-learning classifiers on the one or more video frames to create classification metadata, the classification metadata corresponding to the one or more machine-learning classifiers and one or more probability scores associated with the classification metadata. The system can also include a processing module configured to create one or more interaction triggers based on a set of rules. The interaction triggers can be configured to trigger one or more actions with regard to the video content based on the classification metadata and, optionally, based on the one or more probability scores.

According to another example embodiment of the present disclosure, a method for interactive video content delivery is provided. An example method includes receiving a video content including one or more video frames, running one or more machine-learning classifiers on the one or more video frames to create classification metadata, the classification metadata corresponding to the one or more machine-learning classifiers and one or more probability scores associated with the classification metadata, creating one or more interaction triggers based on a set of rules, determining that a condition for triggering at least one of the triggers is met, and triggering the one or more actions with regard to the video content based on the determination, the classification metadata, and the probability score.

In further embodiments, the method steps are stored on a machine-readable medium comprising computer instructions, which when implemented by a computer, perform the method steps. In yet further example embodiments, hardware systems or devices can be adapted to perform the recited method steps. Other features, examples, and embodiments are described below.

### BRIEF DESCRIPTION OF THE DRAWINGS

Embodiments are illustrated by way of example, and not by limitation in the figures of the accompanying drawings, in which like references indicate similar elements.

FIG. 1 shows an example system architecture for interactive video content delivery, according to one example embodiment.

FIG. 2 shows an example system architecture for interactive video content delivery, according to another example embodiment.

FIG. 3 is a process flow diagram illustrating a method for interactive video content delivery, according to an example embodiment.

FIG. 4 shows an example graphical user interface of a user device, on which a frame of video content (e.g., a movie) can be displayed, according to an example embodiment.

FIG. 5 illustrates an example graphical user interface of a user device showing additional video content options which include overlaying information present in the graphical user interface of FIG. 4, according to one embodiment.

FIG. 6 is a diagrammatic representation of an example machine in the form of a computer system within which a set of instructions for the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents.

The techniques of the embodiments disclosed herein can be implemented using a variety of technologies. For example, the methods described herein are implemented in software executing on a computer system or in hardware utilizing either a combination of microprocessors or other specially designed application-specific integrated circuits (ASICs), programmable logic devices, or various combinations thereof. In particular, the methods described herein are implemented by a series of computer-executable instructions residing on a storage medium such as a disk drive, or computer-readable medium. It should be noted that methods disclosed herein can be implemented by a cellular phone, smart phone, computer (e.g., a desktop computer, tablet computer, laptop computer), game console, handheld gaming device, and so forth.

The technology of this disclosure is concerned with systems and methods for an immersive interaction discovery experience that are disclosed. The technology can be available to users of over-the-top Internet television (e.g., PlayStation Vue®), online film and television program distribution services, on demand-streaming video and music services, or any other distribution and content distribution networks (CDNs). Additionally, the technology can be applied to user generated content (e.g., direct video upload and screen recording).

In general, the present technology provides buffering frames from a video content or its parts, analyzing frames of the video content to determine associated classifications, evaluating the associated classifications against a set of rules, and activating actions based on the evaluation. The video content may include any form of media, including, but not limited to, live streaming, subscription-based streaming services, movies, television, internet videos, user generated video content (e.g., direct video upload or screen recording) and so forth. The technology can allow the processing of video content and the triggering of actions prior to displaying the pre-fetched frames to the user. A plurality of classifiers (e.g., image recognition modules) may be used to analyze each buffered frame and to dynamically and automatically detect one or more assets present in the frame associated with classifications.

Asset types may include actors, landmarks, special effects, products, purchasable items, objects, food, or other detectable assets such as nudity, violence, gore, weapons, profanity, mood, color, and so forth. Each classifier may be based on one or more machine-learning algorithms, including convolutional neural networks, and may generate classification metadata associated with one or more asset types. The classification metadata may be indicative of, for example, whether certain assets are detected in the video content, certain information regarding a detected asset (e.g., identity of an actor, director, genre, product, class of product, type of special effect, and so forth), coordinates or bounding box of the detected asset in the frame, or a magnitude of a detected asset (e.g., a level of violence or gore present in the frame, and so forth).

Controls may be wrapped around each classification, which, based on a set of rules (either predefined or created dynamically), trigger a particular action. The set of rules may be a function of the detected assets in the frame, as well as other classification metadata of the video content, audience members (who is watching or listening), a time of day, ambient noise, environmental parameters, and other suitable inputs. The set of rules may be further tailored based on environmental factors, such as location, group of users, or type of media. For example, a parent may wish for nudity to not be displayed when children are present. In this example, the system may profile a viewing environment, determine characteristics of users viewing the displayed video stream (e.g., determine whether children are present), detect nudity in pre-buffered frames, and remediate (e.g., pause, redact, or obscure) the frames prior to display such that the nudity is not displayed.

Actions may also include asset obscuring (e.g., censoring, overlaying objects, blurring, and so forth), skipping frames, adjusting a volume, alerting a user, notifying a user, requesting a setting, providing related information, generating a query and performing a search for related information or advertisements, opening a related software application, and so forth. The buffering and frame analysis may be performed in near real-time, or alternatively, the video content stream may be pre-processed ahead of time before it is uploaded to a distribution network, in the event of a non-live movie or television show. In various embodiments, the image recognition module(s) can be disposed on a central server, in a cloud-computing based environment, and can perform analysis on frames of video content received from a client, frames of a mirror video stream (when the video is processed in parallel to streaming) played by the client, or frames of a video stream being sent to the client.

The systems and methods of this disclosure may also include tracking a traversal history of the user and providing a graphical user interface (GUI) for user-related information to the video content or a particular frame from one or more entry points. Examples of entry points at which various related information is presented may include pausing the video content stream, selecting particular video content, receiving user input, detecting a user gesture, receipt of a search query, a voice command, and so forth. Related information may include actor information (e.g., a biographical and/or professional description), similar media content (e.g., similar movies), relevant advertisements, products, computer games, or other suitable information based on the analysis of frames of the video content or other metadata. Each item of the related information may be structured as a node. In response to receiving a user selection of a node, information related to the selected node may be presented to the user. The system can track the traversal across a plurality of user selected nodes and generate a user profile based on the traversal history. The system may also record the frame associated with triggering of the entry point. The user profile may be further used to determine user preferences and action patterns in order to predict user needs and to provide information or action options that are relevant to a particular user based on the user profile.

The following detailed description of embodiments includes references to the accompanying drawings, which form a part of the detailed description. Note that the features, structures, or characteristics of embodiments described herein may be combined in any suitable manner in one or more implementations. In the instant description, numerous specific details are provided, such as examples of programming, software modules, user selections, network transactions, hardware modules, hardware circuits, hardware chips, and so forth, to provide a thorough understanding of embodiments. One skilled in the relevant art will recognize, however, that the embodiments can be practiced without one or more of the specific details, or with other methods, components, materials, and so forth. In other instances, well-known structures, materials, or operations are not shown or described in detail to avoid obscuring aspects of the disclosure.

Embodiments of this disclosure will now be presented with reference to accompanying drawings which show blocks, components, circuits, steps, operations, processes, algorithms, and the like, collectively referred to as “elements” for simplicity. These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “computing system” that includes one or more processors. Examples of processors include microprocessors, microcontrollers, central processing units (CPUs), digital signal processors (DSPs), field programmable gate arrays (FPGAs), programmable logic devices (PLDs), state machines, gated logic, discrete hardware circuits, and other suitable hardware configured to perform various functions described throughout this disclosure. One or more processors in the processing system may execute software, firmware, or middleware (collectively referred to as “software”). The term “software” shall be construed broadly to mean processor-executable instructions, instruction sets, code segments, program code, programs, subprograms, software components, applications, software applications, software packages, routines, subroutines, objects, executables, threads of execution, procedures, functions, and the like, whether referred to as software, firmware, middleware, microcode, hardware description language, or otherwise.

Accordingly, in one or more embodiments, the functions described herein may be implemented in hardware, software, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage, solid state memory, or any other data storage devices, combinations of the aforementioned types of computer-readable media, or any other medium that can be used to store computer executable code in the form of instructions or data structures that can be accessed by a computer.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.” The term “or” is used to refer to a nonexclusive “or,” such that “A or B” includes “A but not B,” “B but not A,” and “A and B,” unless otherwise indicated.

The term “video content” can refer to any type of audiovisual media that can be displayed, played, and/or streamed to a user device as defined below. Some examples of the video content include, without limitation, a video stream, a live stream, television program, live television, video-on-demand, movie, film, animation, internet video, multimedia, video game, computer game, and the like. The video content can include user generated content, such as, for example, direct video upload and screen recording. The terms “video content,” “video stream,” “media content,” and “multimedia content” can be used interchangeably. The video content includes a plurality of frames (video frames).

The term “user device” can refer to a device capable of receiving and presenting video content to a user. Some examples of the user device include, without limitation, television devices, smart television systems, computing devices (e.g., tablet computer, laptop computer, desktop computer, or smart phone), projection television systems, digital video recorder (DVR) devices, game consoles, gaming devices, multimedia system entertainment system, computer-implemented video playback devices, mobile multimedia devices, mobile gaming devices, set top box (STB) devices, virtual reality devices, digital video recorders (DVRs), remote-storage DVRs, and so forth. STB devices can be deployed at a user's household to provide the user with the ability to interactively control delivery of video content distributed from a content provider. The terms “user,” “observer,” “audience,” and “player” can be used interchangeably to represent a person using a user device as defined above, or to represent a person watching the video content as described herein. Users can interact with user devices by providing user input or user gestures.

The term “classification metadata” refers to information associated with (and generally, but not necessarily stored with) one or more assets or electronic content items such as video content objects or characteristics. The term “asset” refers to an item of video content, including, for example, an object, text, image, video, audio, individual, parameter, or characteristic included in or associated with the video content. Classification metadata can include information uniquely identifying an asset. Such classification metadata may describe a storage location or other unique identification of the asset. For example, classification metadata associated with an actor appearing in certain frames of video content can include a name and/or identifier, or can otherwise describe a storage location of additional content (or links) relevant to the actor.

Referring now to the drawings, example embodiments are described. The drawings are schematic illustrations of idealized example embodiments. Thus, the example embodiments discussed herein should not be construed as limited to the particular illustrations presented herein. Rather, these example embodiments can include deviations and differ from the illustrations presented herein.

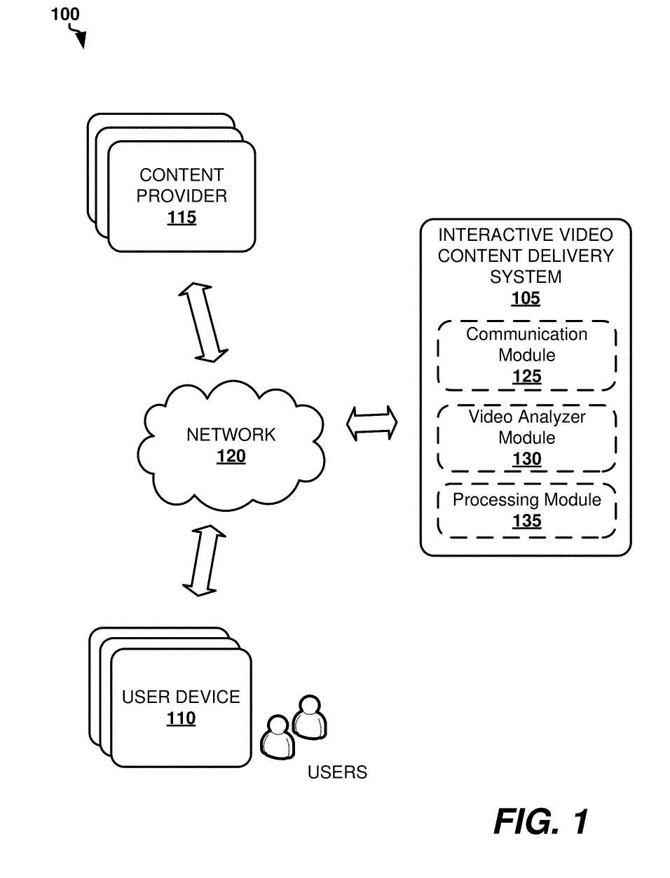

FIG. 1 shows an example system architecture 100 for interactive video content delivery, according to one example embodiment. System architecture 100 includes an interactive video content delivery system 105, one or more user devices 110, and one or more content providers 115. System 105 can be implemented, by way of example, by one or more computer servers or cloud-based services. User devices 110 can include television devices, STBs, computing devices, game consoles, and the like. As such, user devices 110 can include input and output modules to enable users to control playback of video content. The video content can be provided by one or more content providers 115 such as content servers, video streaming services, internet video services, or television broadcasting services. The video content can be generated by users, for example, as direct video upload or screen recording. The term “content provider” can be interpreted broadly to include any party, entity, device, or system that can be involved in the processes of enabling the users to obtain access to specific content via user devices 110. Content providers 115 can also represent or include a Content Distribution Network (CDN).

Interactive video content delivery system 105, user devices 110, and content providers 115 can be operatively connected to one another via a communications network 120. Communications network 120 can refer to any wired, wireless, or optical networks including, for example, the Internet, intranet, local area network (LAN), Personal Area Network (PAN), Wide Area Network (WAN), Virtual Private Network (VPN), cellular phone networks (e.g., packet switching communications network, circuit switching communications network), Bluetooth radio, Ethernet network, an IEEE 802.11-based radio frequency network, IP communications network, or any other data communication network utilizing physical layers, link layer capability, or network layer to carry data packets, or any combinations of the above-listed data networks.

Interactive video content delivery system 105 may include at least one processor and at least one memory for storing processor-executable instructions associated with the methods disclosed herein. As shown in the figure, interactive video content delivery system 105 includes various modules which can be implemented in hardware, software, or both. As such, interactive video content delivery system 105 includes a communication module 125 for receiving video content from content providers 115. Communication module 125 can also transmit video content, edited video content, classification metadata, or other data associated with users or video content to user devices 110 or content providers 115.

Interactive video content delivery system 105 can also include a video analyzer module 130 configured to run one or more machine-learning classifiers on video frames of the video content received via communication module 125. The machine-learning classifiers can include neural networks, deep learning systems, heuristic systems, statistical data systems, and so forth. As explained below, the machine-learning classifiers can include a general object classifier, product classifier, ambient condition classifier, sentiment condition classifier, landmark classifier, people classifier, food classifier, questionable content classifier, and so forth. Video analyzer module 130 can run the above-listed machine-learning classifiers in parallel and independently from one another.

The above classifiers can include an image recognition classifier or a composite recognition classifier. The image recognition classifier can be configured to analyze a still image in one or more video frames. The composite recognition classifier can be configured to analyze: (i) one or more image changes between two or more of the video frames; and (ii) one or more sound changes between two or more of the video frames. As an output, the above classifiers can create classification metadata corresponding to the one or more machine-learning classifiers and one or more probability scores associated with the classification metadata. The probability scores can refer to a confidence level (e.g., factor, weight) that a particular video frame includes or is associated with a certain asset (e.g., an actor, object, or purchasable item appearing in the video frame).

In some embodiments, video analyzer module 130 may perform analysis of real time video content by buffering and delaying the content delivery by a time necessary to process video frames of the real time video. In other embodiments, video analyzer module 130 can perform analysis of the video content intended for on-demand delivery. As mentioned above, live video content can be buffered in the memory of interactive video content delivery system 105 so that the video content is delivered and presented to the user with a slight delay to enable video analyzer module 130 to perform classification of the video content.

Interactive video content delivery system 105 may also include a processing module 135 configured to create one or more interaction triggers based on a set of rules. The interaction triggers can be configured to trigger one or more actions with regard to the video content based on the classification metadata and, optionally, the probability scores. The rules can be predetermined or dynamically selected based on one or more of the following: a user profile, a user setting, a user preference, a viewer identity, a viewer age, and an environmental condition. The actions can include editing of the video content (e.g., redacting, obscuring, highlighting, adjusting color or audio characteristics, and so forth), controlling delivery of video content (e.g., pausing, skipping, and stopping), and presenting additional information associated with the video content (e.g., alerting the user, notifying the user, providing additional information about objects, landmarks, people, and so forth, which are present in the video content, providing hyperlinks, and enabling the user to make a purchase).

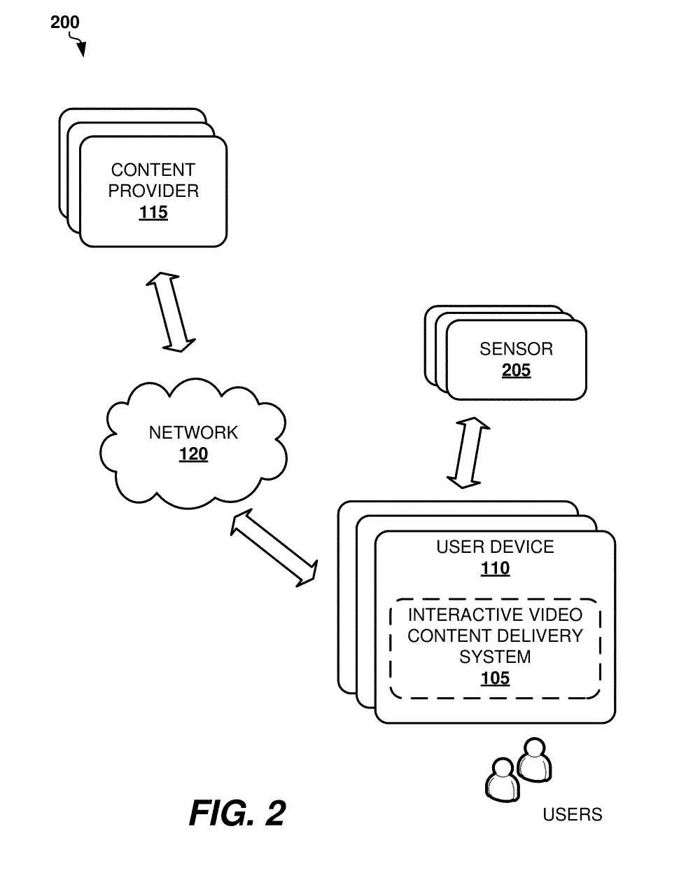

FIG. 2 shows an example system architecture 200 for interactive video content delivery, according to another example embodiment. Similar to FIG. 1, system architecture 200 includes interactive video content delivery system 105, one or more user devices 110, and one or more content providers 115. In FIG. 2, however, interactive video content delivery system 105 is part of, or integrated with, one or more user devices 110. In other words, interactive video content delivery system 105 can provide video processing (as described herein) locally at the user's location. For example, interactive video content delivery system 105 can be a functionality of an STB or game console. The operation and functionalities of interactive video content delivery system 105 and other elements of system architecture 200 are the same or substantially the same as described above with reference to FIG. 1.

FIG. 2 also shows one or more sensors 205 communicatively coupled to user devices 110. Sensors 205 can be configured to detect, determine, identify, or measure various parameters associated with one or more users, the user's home (premises), the user's environmental or ambient parameters, and the like. Some examples of sensors 205 include a video camera, microphone, motion sensor, depth camera, photodetector, and so forth. For example, sensors 205 can be used to detect and identify users, determine if children watch or access certain video content, determine lighting conditions, measure noise levels, track user's behavior, detect user's mood, and so forth.

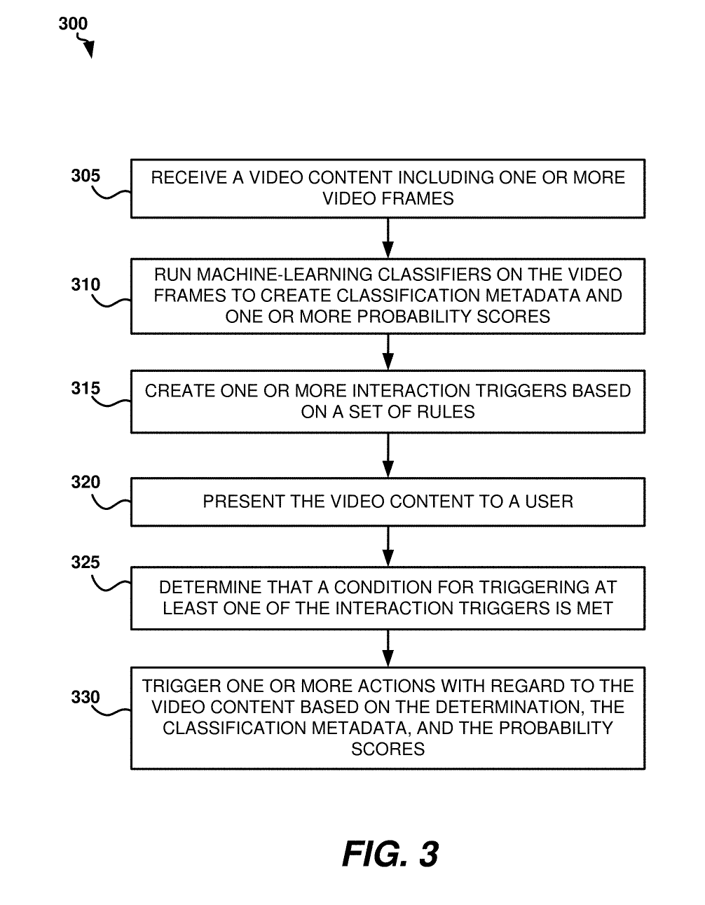

FIG. 3 is a process flow diagram showing a method 300 for interactive video content delivery, according to an example embodiment. Method 300 can be performed by processing logic that includes hardware (e.g., decision-making logic, dedicated logic, programmable logic, application-specific integrated circuit), software (such as software run on a general-purpose computer system or a dedicated machine), or a combination of both. In example embodiments, the processing logic refers to one or more elements of interactive video content delivery system 105 of FIGS. 1 and 2. Operations of method 300 recited below can be implemented in an order different than the order described and shown in the figure. Moreover, method 300 may have additional operations not shown herein, but which can be evident from the disclosure to those skilled in the art. Method 300 may also have fewer operations than shown in FIG. 3 and described below.

Method 300 commences at operation 305 with communication module 125 receiving a video content, the video content including one or more video frames. The video content can be received from one or more content providers 115, CDN, or local data storage. As explained above, the video content can include multimedia content (e.g., a movie, television program, video-on-demand, audio, audio-on-demand), gaming content, sport content, audio content, and so forth. The video content can include a live stream or pre-recorded content.

At operation 310, processing module 130 can run one or more machine-learning classifiers on one or more of the video frames to create classification metadata corresponding to the one or more machine-learning classifiers and to the one or more probability scores associated with the classification metadata. The machine-learning classifiers can be run in parallel. Additionally, the machine-learning classifiers can run on the video content before the video content is uploaded to the CDN, content providers 115, or streamed to the user or user device 110.

The classification metadata can represent or be associated with one or more assets of the video content, ambient or environmental conditions, user information, and so forth. The assets of the video content can relate to objects, people (e.g., actors, movie directors, and so forth), food, landmarks, music, audio items, or other items present in the video content.

At operation 315, processing module 135 can create one or more interaction triggers based on a set of rules. The interaction triggers are configured to trigger one or more actions with regard to the video content based on the classification metadata, and optionally, based on one or more of the probability scores. The set of rules can be based on one or more of the following: a user profile, a user setting, a user preference, a viewer identity, a viewer age, and an environmental condition. In some embodiments, the set of rules can be predetermined. In other embodiments, the set of rules can be dynamically created, updated, or selected to reflect user preferences, user behavior, or other related circumstances.

At operation 320, user device 110 presents the video content to one or more users. The video content can be streamed after operations 305-315 are performed. User device 110 can measure one or more parameters by sensors 205 upon presenting the video content at operation 320.

At operation 325, interactive video content system 105 or user device 110 can determine that a condition for triggering at least one or more interaction triggers is met. The condition can be predetermined and can be one of a plurality of conditions. In some embodiments, the condition refers to, or is associated with, an entry point. In method 300, interactive video content system 105 or any other element of system architecture 100 or 200 can create one or more entry points corresponding to the interaction triggers. Each of the entry points includes a user input associated with the video content, or a user gesture associated with the video content. Particularly, each of the entry points can include one or more of the following: a pause of the video content, a jump point of the video content, a bookmark of the video content, a location marker of the video content, changes in user environment detected by connected sensor, and a search result associated with the video content. In other words, in one example embodiment, operation 325 can determine whether a user paused the video content, pressed a predetermined button, or whether the content reached a location marker. In another example embodiment, operation 325 can utilize sensors on user device 110 to determine whether changes in user environment create conditions to trigger an interaction trigger. For example, a camera sensor on user device 110 can determine when a child walks into a room and interactive video content system 105 or user device 110 can automatically obscure questionable content (e.g., content that may not be appropriate for children). Furthermore, another sensor-driven entry point can include voice control (i.e., the user can use a microphone connected to user device 110 to ask, “Who is the actor on the screen?” In response, interactive video content system 105 or user device 110 can present data responsive to the user's query.

At operation 330, interactive video content system 105 or user device 110 triggers one or more of the actions with regard to the video content and in response to the determination made at operation 325. In some embodiments, the actions can be based on the classification metadata of a frame associated with one of the entry points of the video content. Generally, the actions can relate to providing additional information, video content options, links (hyperlinks), highlighting, modifying the video content, controlling the playback of the video content, and so forth. An action may depend on the classification metadata (i.e., based on the machine-learning classifier generating the metadata). It should be understood that interaction triggers can present information and actions on a primary screen or a secondary screen. For example, the name of a landmark can be displayed on a device (e.g. a smartphone) that matches the frame on the primary screen. In another example, a secondary screen can display purchasable items in the frame being watched on the primary screen, thereby allowing the direct purchase of items on the secondary screen.

In various embodiments, each of the machine-learning classifiers can be of at least two types: (i) an image recognition classifier configured to analyze a still image in one of the video frames, and (ii) a composite recognition classifier configured to analyze: (a) one or more image changes between two or more of the video frames; and (b) one or more sound changes between two or more of the video frames.

One embodiment provides a general object classifier configured to identify one or more objects present in the one or more video frames. For this classifier, the actions to be taken upon triggering the one or more interaction triggers can include one or more of the following: replacing the objects with new objects in the video frames, automatically highlighting the objects, recommending purchasable items represented by the objects, editing the video content based on the identification of the objects, controlling delivery of the video content based on the identification of the objects, and presenting search options related to the objects.

Another embodiment provides a product classifier configured to identify one or more purchasable items present in the video frames. For this classifier, the actions to be taken upon triggering the one or more interaction triggers can include, for example, providing one or more links to enable a user to make a purchase of one or more purchasable items.

Yet another embodiment provides an ambient condition classifier configured to determine environmental conditions associated with the video frames. Here, the classification metadata can be created based on the following sensor data: lightning conditions of premises where one or more observers are watching the video content, a noise level of the premises, an audience observer type associated with the premises, an observer identification, and a current time of day. The sensor data is obtained using one or more sensors 205. For this classifier, actions to be taken upon triggering the one or more interaction triggers include one or more of the following: editing the video content based on the environmental conditions, controlling delivery of the video content based on the environmental conditions, providing recommendations associated with the video content or another media content based on the environmental conditions, and providing another media content associated with the environmental conditions.

Another embodiment provides a sentiment condition classifier configured to determine a sentiment level associated with the one or more video frames. In this embodiment, the classification metadata can be created based on one or more of the following: color data of one or more video frames, audio information of one or more video frames, and user behavior in response to watching the video content. In addition, in this embodiment, the actions to be taken upon triggering the one or more interaction triggers can include one or more of the following: providing recommendations related to another media content associated with the sentiment level and providing other media content associated with the sentiment level.

One embodiment provides a landmark classifier configured to identify a landmark present in the one or more video frames. For this classifier, the actions to be taken upon triggering the one or more interaction triggers can include one or more of the following: labeling the identified landmark in one or more video frames, providing recommendations related to another media content associated with the identified landmark, providing other media content associated with the identified landmark, editing the video content based on the identified landmark, controlling delivery of the video content based on the identified landmark, and presenting search options related to the identified landmark.

Another embodiment provides a people classifier configured to identify one or more individuals present in the video frames. For this classifier, the actions to be taken upon triggering the one or more interaction triggers include one or more of the following: labeling one or more individuals in one or more video frames, providing recommendations related to another media content associated with one or more individuals, providing other media content associated with one or more individuals, editing the video content based on one or more individuals, controlling delivery of the video content based on one or more individuals, and presenting search options related to one or more individuals.

Yet another embodiment provides a food classifier configured to identify one or more food items present in the one or more video frames. For this classifier, the actions to be taken upon triggering of the one or more interaction triggers include one or more of the following: labeling one or more food items in one or more video frames, providing nutritional information related to one or more food items, providing purchase options for a user to make a purchase of purchasable items associated with one or more food items, providing media content associated with one or more food items, and providing search options related to one or more food items.

An embodiment provides a questionable content classifier configured to detect questionable content in the one or more video frames. The questionable content may include one or more of the following: nudity, weapons, alcohol, tobacco, drugs, blood, hate speech, profanity, gore, and violence. For this classifier, the actions to be taken upon triggering the one or more interaction triggers can include one or more of the following: automatically obscuring the questionable content in one or more video frames before it is displayed to a user, skipping a portion of the video content associated with the questionable content, editing the video content based on the questionable content, adjusting audio of the video content based on the questionable content, adjusting an audio volume level based on the questionable content, controlling delivery of the video content based on the questionable content, and notifying a user about the questionable content.

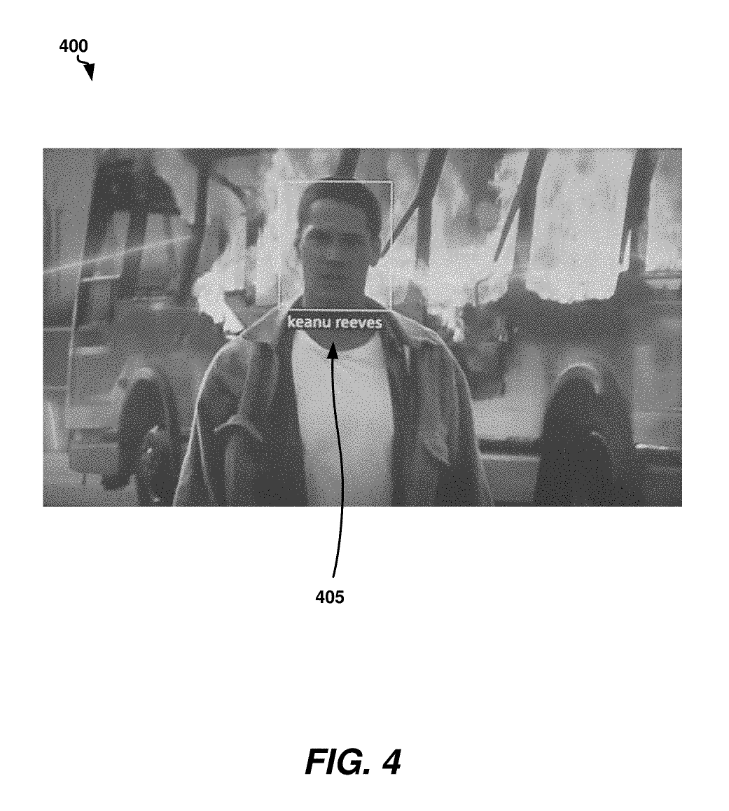

FIG. 4 shows an example graphical user interface (GUI) 400 of user device 110 for displaying at least one frame of video content (e.g., a movie), according to one embodiment. This example GUI shows that when a user pauses playback of video content, an entry point is detected by interactive video content system 105. In response to the detection, interactive video content system 105 triggers an action associated with an actor identified in the video frame. The action can include providing overlaying information 405 about the actor (in this example, the actor's name and face frame are shown). Notably, information 405 about the actor can be generated dynamically in real time, but this is not necessary. Information 405 can be generated based on buffered video content.

In some embodiments, overlaying (or superimposed) information 405 can include hyperlink. Overlaying information can also be represented by an actionable “soft” button. With such a button, the user can select, press, click, or otherwise activate overlaying information 405 by a user input or user gesture.

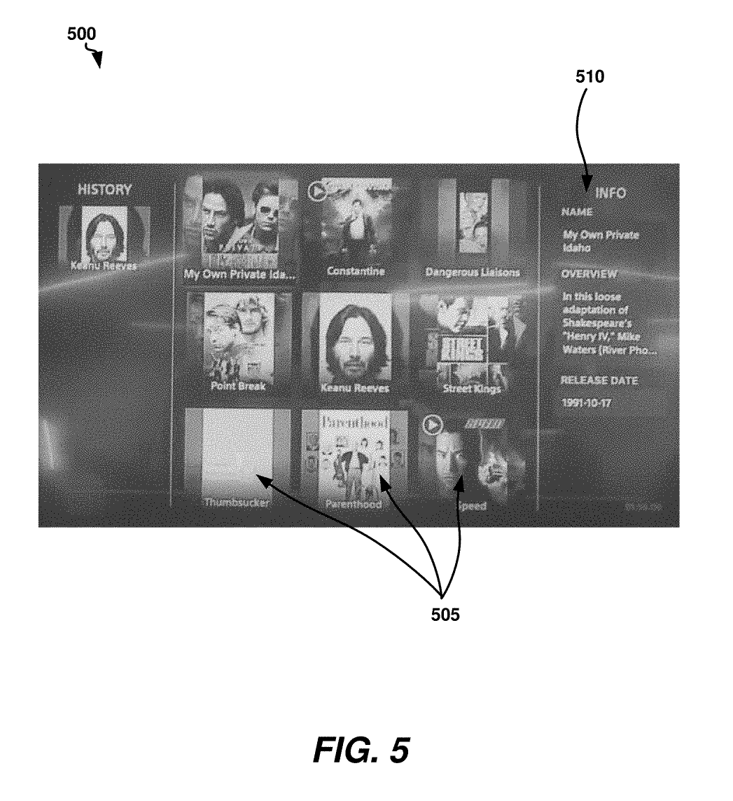

FIG. 5 shows an example graphical user interface 500 of user device 110 showing additional video content options 505 which are associated with overlaying information 405 present in the graphical user interface 400 of FIG. 4, according to one embodiment. In other words, GUI 500 is displayed when the user activates overlaying information 405 in GUI 400.

As shown in FIG. 5, GUI 500 includes a plurality of video content options 505 such as movies with the same actor as identified in FIG. 4. GUI 500 can also include an information container 510 providing data about the actor as identified in FIG. 4. Information container 510 can include text, images, video, multimedia, hyperlinks, and so forth. The user can also select one or more video content options 505 and these selections can be saved to a user profile such that the user can access these video content options 505 at a later time. In addition, machine-learning classifiers can monitor user behavior represented by the selections of the user to determine the user preferences. The user preferences can be further utilized by system 105 in selecting and providing recommendations to the user.

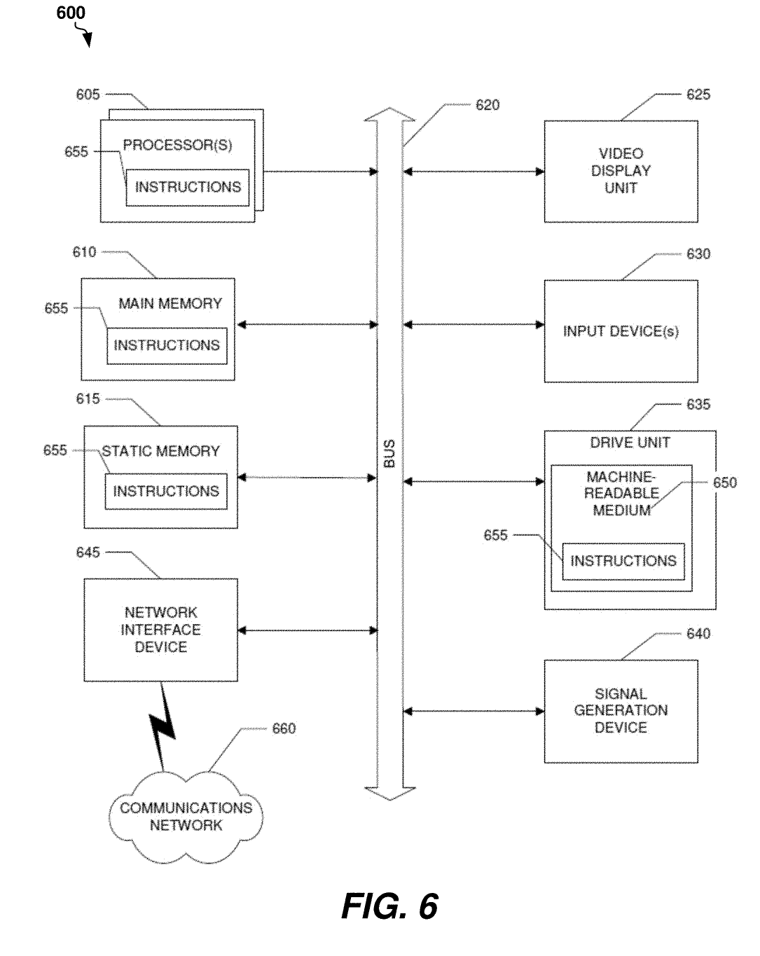

FIG. 6 shows a diagrammatic representation of a computing device for a machine in the example electronic form of a computer system 600, within which a set of instructions for causing the machine to perform any one or more of the methodologies discussed herein can be executed. In example embodiments, the machine operates as a standalone device, or can be connected (e.g., networked) to other machines. In a networked deployment, the machine can operate in the capacity of a server, a client machine in a server-client network environment, or as a peer machine in a peer-to-peer (or distributed) network environment. The machine can be a personal computer (PC), tablet PC, game console, gaming device, set-top box (STB), television device, cellular telephone, portable music player (e.g., a portable hard drive audio device), web appliance, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein. Computer system 600 can be an instance of interactive video content delivery system 105, user device 110, or content provider 115.

The example computer system 600 includes a processor or multiple processors 605 (e.g., a central processing unit (CPU), a graphics processing unit (GPU), or both), and a main memory 610 and a static memory 615, which communicate with each other via a bus 620. The computer system 600 can further include a video display unit 625 (e.g., a LCD). The computer system 600 also includes at least one input device 630, such as an alphanumeric input device (e.g., a keyboard), a cursor control device (e.g., a mouse), a microphone, a digital camera, a video camera, and so forth. The computer system 600 also includes a disk drive unit 635, a signal generation device 640 (e.g., a speaker), and a network interface device 645.

The drive unit 635 (also referred to as the disk drive unit 635) includes a machine-readable medium 650 (also referred to as a computer-readable medium 650), which stores one or more sets of instructions and data structures (e.g., instructions 655) embodying or utilized by any one or more of the methodologies or functions described herein. The instructions 655 can also reside, completely or at least partially, within the main memory 610 and/or within the processors 605 during execution thereof by the computer system 600. The main memory 610 and the processor(s) 605 also constitute machine-readable media.

The instructions 655 can be further transmitted or received over a communications network 660 via the network interface device 645 utilizing any one of a number of well-known transfer protocols (e.g., Hyper Text Transfer Protocol (HTTP), CAN, Serial, and Modbus). The communications network 660 includes the Internet, local intranet, Personal Area Network (PAN), Local Area Network (LAN), Wide Area Network (WAN), Metropolitan Area Network (MAN), virtual private network (VPN), storage area network (SAN), frame relay connection, Advanced Intelligent Network (AlN) connection, synchronous optical network (SONET) connection, digital T1, T3, E1 or E3 line, Digital Data Service (DDS) connection, Digital Subscriber Line (DSL) connection, Ethernet connection, Integrated Services Digital Network (ISDN) line, cable modem, Asynchronous Transfer Mode (ATM) connection, or an Fiber Distributed Data Interface (FDDI) or Copper Distributed Data Interface (CDDI) connection. Furthermore, communications network 660 can also include links to any of a variety of wireless networks including Wireless Application Protocol (WAP), General Packet Radio Service (GPRS), Global System for Mobile Communication (GSM), Code Division Multiple Access (CDMA) or Time Division Multiple Access (TDMA), cellular phone networks, Global Positioning System (GPS), cellular digital packet data (CDPD), Research in Motion, Limited (RIM) duplex paging network, Bluetooth radio, or an IEEE 802.11-based radio frequency network.

While the machine-readable medium 650 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, XML, Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C#, .NET, Adobe Flash, Perl, UNIX Shell, Visual Basic or Visual Basic Script, Virtual Reality Markup Language (VRML), ColdFusion™ or other compilers, assemblers, interpreters, or other computer languages or platforms.

Thus, the technology for interactive video content delivery is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A system for interactive video content delivery, the system comprising:
a communication module configured to receive a video content, the video content including one or more video frames;
a video analyzer module configured to run one or more machine-learning classifiers on the one or more video frames to create classification metadata, the classification metadata corresponding to the one or more machine-learning classifiers and one or more probability scores associated with the classification metadata; and
a processing module configured to create one or more interaction triggers based on a set of rules, the one or more interaction triggers being configured to trigger one or more actions with regard to the video content based on the classification metadata.

2. A method for interactive video content delivery, the method comprising:
receiving, by a communication module, a video content, the video content including one or more video frames;
running, by a processing module, one or more machine-learning classifiers on the one or more video frames to create classification metadata, the classification metadata corresponding to the one or more machine-learning classifiers and one or more probability scores associated with the classification metadata; and
creating, by the processing module, one or more interaction triggers based on a set of rules, the one or more interaction triggers being configured to trigger one or more actions with regard to the video content based on the classification metadata.

3. The method of claim 1, in which the triggering of the one or more actions is further based on the one or more probability scores.

4. The method of claim 1, in which the video content includes a live video, the live video being delayed until the one or more machine-learning classifiers are run on the one or more video frames.

5. The method of claim 1, in which the video content includes video-on-demand, the one or more machine-learning classifiers being run on the one or more video frames before the video content is uploaded to a content distribution network (CDN).

6. The method of claim 1, in which the video content includes a video game.

7. The method of claim 1, further comprising:
determining that a condition for triggering at least one of the one more interaction triggers is met; and
in response to the determination, triggering the one or more actions with regard to the video content.

8. The method of claim 1, in which the one or more machine-learning classifiers include at least one of an image recognition classifier configured to analyze a still image in one of the video frames, and a composite recognition classifier configured to analyze: (i) one or more image changes between two or more of the video frames; and (ii) one or more sound changes between two or more of the video frames.

9. The method of claim 1, further comprising creating one or more entry points corresponding to the one or more interaction triggers, in which each of the one or more entry points include a user input associated with the video content or a user gesture associated with the video content.

10. The method of claim 9, in which each of the one or more entry points include one or more of the following: a pause of the video content, a jump point of the video content, a bookmark of the video content, a location marker of the video content, a search result associated with the video content, and a voice command.

11. The method of claim 9, in which the one or more actions are based on the classification metadata of a frame associated with one of the entry points of the video content.

12. The method of claim 1, in which the set of rules are based on one or more of the following: a user profile, a user setting, a user preference, a viewer identity, a viewer age, and an environmental condition.

13. The method of claim 8, in which:
the one or more machine-learning classifiers include a general object classifier configured to identify one or more objects present in the one or more video frames; and
the one or more actions to be taken upon triggering the one or more interaction triggers include one or more of the following: replacing the one or more objects with new objects in the one or more video frames, automatically highlighting the objects, recommending purchasable items represented by the one or more objects, editing the video content based on the identification of the one or more objects, controlling delivery of the video content based on the identification of the one or more objects, and presenting search options related to the one or more objects.

14. The method of claim 8, in which:
the one or more machine-learning classifiers include a product classifier configured to identify one or more purchasable items present in the one or more video frames; and
the one or more actions to be taken upon triggering of the one or more interaction triggers include providing the one or more links enabling a user to make a purchase of the one or more purchasable items.

15. The method of claim 8, in which:
the one or more machine-learning classifiers include an ambient condition classifier configured to determine environmental conditions associated with the one or more video frames;
the classification metadata is created based on the following sensor data: lighting conditions of premises where one or more observers are watching the video content, a noise level of the premises, an audience observer type associated with the premises, an observer identification, a current time of day, in which the sensor data is obtained using one or more sensors; and
the one or more actions to be taken upon triggering of the one or more interaction triggers include one or more of the following: editing the video content based on the environmental conditions, controlling delivery of the video content based on the environmental conditions, providing recommendations associated with the video content or another media content based on the environmental conditions, and providing another media content associated with the environmental conditions.

16. The method of claim 8, in which:
the one or more machine-learning classifiers include a sentiment condition classifier configured to determine a sentiment level associated with the one or more video frames;
the classification metadata is created based on one or more of the following: color information of the one or more video frames, audio information of the one or more video frames, a user behavior exhibited by the user upon watching the video content; and
the one or more actions to be taken upon triggering of the one or more interaction triggers include one or more of the following: providing recommendations related to another media content associated with the sentiment level and providing another media content associated with the sentiment level.

17. The method of claim 8, in which:
the one or more machine-learning classifiers include a landmark classifier configured to identify a landmark present in the one or more video frames; and
the one or more actions to be taken upon triggering the one or more interaction triggers include one or more of the following: labeling the identified landmark in the one or more video frames, providing recommendations related to another media content associated with the identified landmark, providing another media content associated with the identified landmark, editing the video content based on the identified landmark, controlling delivery of the video content based on the identified landmark, and presenting search options related to the identified landmark.

18. The method of claim 8, in which:
the one or more machine-learning classifiers include a people classifier configured to identify one or more individuals present in the one or more video frames; and
the one or more actions to be taken upon triggering the one or more interaction triggers include one or more of the following: labeling the one or more individuals in the one or more video frames, providing recommendations related to another media content associated with the one or more individuals, providing another media content associated with the one or more individuals, editing the video content based on the one or more individuals, controlling delivery of the video content based on the one or more individuals, and presenting search options related to the one or more individuals.

19. The method of claim 8, in which:
the one or more machine-learning classifiers include a food classifier configured to identify one or more food items present in the one or more video frames; and
the one or more actions to be taken upon triggering of the one or more interaction triggers include one or more of the following: labeling the one or more food items in the one or more video frames, providing nutritional information related to the one or more food items, providing purchase options for a user to make a purchase of purchasable items associated with the one or more food items, providing media content associated with the one or more food items, and providing search options related to the one or more food items.

20. The method of claim 8, in which:
the one or more machine-learning classifiers include a questionable content classifier configured to detect questionable content in the one or more video frames, the questionable content including one or more of the following: nudity, weapons, alcohol, tobacco, drugs, blood, hate speech, profanity, gore, and violence; and
the one or more actions to be taken upon triggering of the one or more interaction triggers include one or more of the following: automatically obscuring the questionable content in the one or more video frames before it is displayed to a user, skipping a portion of the video content associated with the questionable content, editing the video content based on the questionable content, adjusting audio of the video content based on the questionable content, adjusting an audio volume level based on the questionable content, controlling delivery of the video content based on the questionable content, and notifying a user about the questionable content.

21. A system for interactive video content delivery, the system comprising:
a communication module to receive a video content, the video content including one or more video frames;
a video analyzer module to run one or more machine learning classifiers on the one or more video frames to create one or more classification metadata sets corresponding to the one or more machine learning classifiers and one or more probability scores associated with the one or more classification metadata sets; and
a processing module to create one or more interaction triggers based on a set of rules, the one more interaction triggers being configured to trigger one or more actions with regard to the video content based on the one or more classification metadata sets.

22. A non-transitory processor-readable medium having instructions stored thereon, which when executed by one or more processors, cause the one or more processors to implement a method for skipping one or more unwanted portions of a media content, the method comprising:
a communication module configured to receive a video content, the video content including one or more video frames;
a video analyzer module configured to run one or more machine-learning classifiers on the one or more video frames to create classification metadata corresponding to the one or more machine-learning classifiers and one or more probability scores associated with the classification metadata; and
a processing module configured to create one or more interaction triggers based on a set of rules, the one or more interaction triggers being configured to trigger one or more actions with regard to the video content based on the classification metadata.
